(19) United States
(12) Patent Application Publication
(10) Pub. No.: US 2019/0086848 A1
(43) Pub. Date: Mar. 21, 2019

(54) FIXING DEVICE AND IMAGE FORMING DEVICE

(71) Applicants: KABUSHIKI KAISHA TOSHIBA, Tokyo (JP); TOSHIBA TEC KABUSHIKI KAISHA, Tokyo (JP)

(72) Inventor: Toshiya Inomata, Yokohama Kanagawa (JP)

(21) Appl. No.: 15/708,375

(22) Filed: Sep. 19, 2017

(51) Int. Cl. G03G 15/20

(52) U.S. Cl. CPC G03G 15/2078; G03G 2215/2016; G03G 15/2089

(57) ABSTRACT

A fixing device includes a heating device, a fixing belt, a pressing roller, a thermostat, and a temperature sensor. The fixing belt is heated by the heating device. The pressing roller is pressed toward the outer surface of the fixing belt, and forms a fixing nip portion through which a recording medium passes between the pressing roller and the outer surface of the fixing belt. The thermostat is disposed in proximity to the fixing belt. The temperature sensor is disposed in proximity to the fixing belt, and detects the temperature of the fixing belt and outputs a detection signal to a temperature control portion of the heating device. The thermostat and the temperature sensor are disposed on the same surface side of the fixing belt and also in the same phase position in the width direction of the fixing belt.

### FIELD

Embodiments described herein relate generally to a fixing device and an image forming device.

### BACKGROUND

An image forming device such as a multi-function peripheral (MFP), a copying machine, or a printer includes a fixing device for fixing a toner image transferred onto a recording medium such as a recording paper.

As a fixing device, there is a fixing device configured such that a fixing belt which rotates is heated by a heating device, and a pressing roller is pressed against the outer surface of the fixing belt. A portion between the outer surface of the fixing belt and the pressing roller of this fixing device is defined as a fixing nip portion through which a recording medium as a fixing target passes. Fixing of the toner to the recording medium is performed while the recording medium passes through the fixing nip portion.

The heating device is configured such that, for example, a heat source such as a halogen heater is housed in a heat roller. An inner surface of the fixing belt is in contact with the outer circumferential surface of the heat roller. The heat roller holds the fixing belt from the inside while transmitting the heat of the heat source to the fixing belt.

In the fixing device as described above, it is necessary to appropriately control the temperature of the fixing belt. For example, it is not desirable that the temperature of the fixing belt becomes unnecessarily high, and therefore, a thermostat is disposed in proximity to the fixing belt. The thermostat interrupts the current flow in the heat source of the heating device according to the temperature in the vicinity of the fixing belt. Further, aside from the thermostat, a temperature sensor such as a thermopile-type infrared temperature sensor or a thermistor is disposed in proximity to the fixing belt. This temperature sensor detects the temperature on the fixing belt, and outputs the detection signal to a temperature control portion of the heating device. The temperature control portion appropriately controls the output of the heating device based on the detection temperature of the temperature sensor.

However, in the above-mentioned fixing device, the thermostat and the temperature sensor are disposed at positions shifted in the width direction of the fixing belt, and therefore, a difference in the temperature on the fixing belt may occur between the sensing operating position of the thermostat and the detection position of the temperature sensor in some cases. In the fixing belt, a difference in the surface temperature occurs between a region which comes into contact with the recording medium and a region which does not come into contact with the recording medium in the fixing nip portion. Due to this, an event in which the temperature on the fixing belt is different between the sensing operating position of the thermostat and the detection position of the temperature sensor occurs depending on the size of the recording medium to be used or the feeding position in the width direction of the recording medium.

Therefore, a fixing device capable of reducing the difference between the temperature of a region sensed by a thermostat and the temperature of a region detected by a temperature sensor on the fixing belt regardless of the size of the recording medium to be used or the feeding position in the width direction of the recording medium is awaited.

### DESCRIPTION OF THE DRAWINGS

FIG. 1 is a side view of an image forming device including a fixing device according to an embodiment.

FIG. 2 is a top view of the fixing device.

FIG. 3 is a cross-sectional view taken along the III-III line of FIG. 2 of the fixing device.

### DETAILED DESCRIPTION

In general, fixing device of an embodiment includes a heating device, a fixing belt, a pressing roller, a thermostat, and a temperature sensor. The fixing belt is heated by the heating device and also rotates. The pressing roller is pressed toward the outer surface of the fixing belt, and also forms a fixing nip portion through which a recording medium as a fixing target passes between the pressing roller and the outer surface of the fixing belt. The thermostat is disposed in proximity to the fixing belt, and interrupts the current flow in the heating device according to a temperature in the vicinity of the fixing belt. The temperature sensor is disposed in proximity to the fixing belt, and detects the temperature of the fixing belt and outputs a detection signal to a temperature control portion of the heating device. The thermostat and the temperature sensor are disposed on the same surface side of the fixing belt and also in the same phase position in the width direction of the fixing belt.

Hereinafter, an image forming device of an embodiment will be described with reference to the drawings. Incidentally, the same reference numerals are assigned to the same components in the respective drawings.

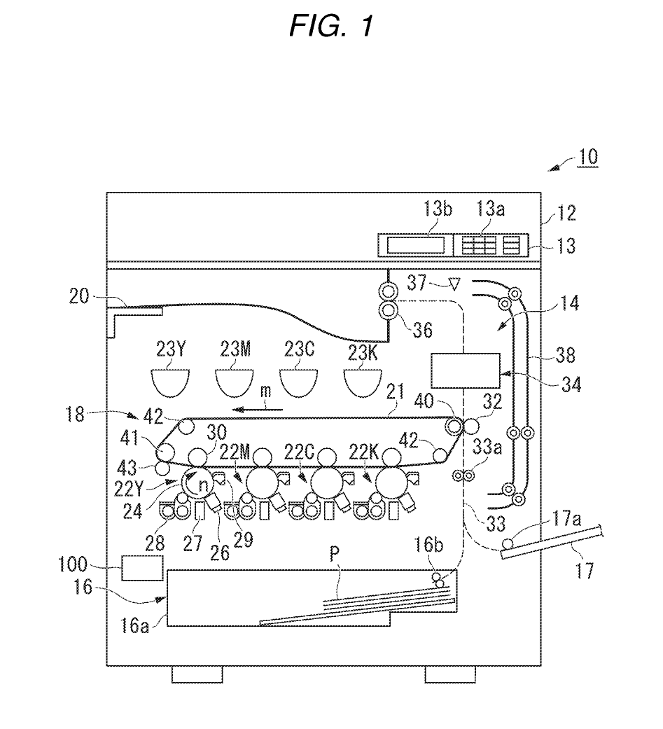

FIG. 1 is a side view showing the entire configuration of an image forming device 10 of an embodiment. For example, the image forming device 10 is a multi-function peripheral. However, the image forming device 10 is not limited to the above-mentioned example, and may be a copying machine, a printer, or the like.

The image forming device 10 includes a scanner portion 12, a control panel 13, a main body portion 14, and a control portion 100. The main body portion 14 includes a paper feed cassette portion 16, a printer portion 18, a fixing device 34, and the like. The control portion 100 controls the whole image forming device 10. For example, the control portion 100 controls the operations of the scanner portion 12, the control panel 13, the paper feed cassette portion 16, the printer portion 18, the fixing device 34, and the like.

The scanner portion 12 reads an original document image. The control panel 13 includes an input key 13a and a display portion 13b. For example, the input key 13a receives input from a user. For example, the display portion 13b is a touch panel type. The display portion 13b receives input from a user and performs display to the user.

The paper feed cassette portion 16 includes a cassette main body 16a and a pickup roller 16b. The cassette main body 16a stores a sheet P which is a recording medium. The pickup roller 16b picks up the sheet P from the cassette main body 16a. The sheet P picked up from the cassette main body 16a is fed to a conveyance path 33.

The printer portion 18 forms an image. The printer portion 18 performs, for example, image formation of an original document image read by the scanner portion 12. The printer portion 18 includes an intermediate transfer belt 21. In the printer portion 18, the intermediate transfer belt 21 is supported by a backup roller 40, a driven roller 41, and a tension roller 42. The backup roller 40 includes a drive portion (not shown). The printer portion 18 rotates the intermediate transfer belt 21 in the direction of the arrow m.

The printer portion 18 includes four image forming stations 22Y, 22M, 22C, and 22K. The image forming stations 22Y, 22M, 22C, and 22K are provided for forming images of yellow (Y), magenta (M), cyan (C), and black (K), respectively. The image forming stations 22Y, 22M, 22C, and 22K are arranged in parallel along the rotational direction of the intermediate transfer belt 21 on the lower side of the intermediate transfer belt 21.

The printer portion 18 includes cartridges 23Y, 23M, 23C, and 23K above the image forming stations 22Y, 22M, 22C, and 22K, respectively. The cartridges 23Y, 23M, 23C, and 23K store replenishment toners of yellow (Y), magenta (M), cyan (C), and black (K), respectively.

Hereinafter, among the image forming stations 22Y, 22M, 22C, and 22K, the image forming station 22Y for Y (yellow) will be described as an example. Incidentally, the image forming stations 22M, 22C, and 22K have the same configuration as the image forming station 22Y, and therefore, a detailed description will be omitted.

The image forming station 22Y includes an electrifying charger 26, an exposure scanning head 27, a developing device 28, and a photoconductor cleaner 29. The electrifying charger 26, the exposure scanning head 27, the developing device 28, and the photoconductor cleaner 29 are arranged around a photoconductive drum 24 which rotates in the direction of the arrow n.

The image forming station 22Y includes a primary transfer roller 30. The primary transfer roller 30 faces the photoconductive drum 24 through the intermediate transfer belt 21.

The image forming station 22Y exposes the photoconductive drum 24 to light by the exposure scanning head 27 after electrifying the photoconductive drum 24 by the electrifying charger 26. The image forming station 22Y forms an electrostatic latent image on the photoconductive drum 24. The developing device 28 develops the electrostatic latent image on the photoconductive drum 24 using a two-component developer formed of a toner and a carrier.

The primary transfer roller 30 primarily transfers a toner image formed on the photoconductive drum 24 to the intermediate transfer belt 21. The image forming stations 22Y, 22M, 22C, and 22K form a color toner image on the intermediate transfer belt 21 by the primary transfer roller 30. The color toner image is formed by sequentially superimposing the toner images of yellow (Y), magenta (M), cyan (C), and black (K). The photoconductor cleaner 29 removes the toner remaining on the photoconductive drum 24 after primary transfer.

The printer portion 18 includes a secondary transfer roller 32. The secondary transfer roller 32 faces the backup roller 40 through the intermediate transfer belt 21. The secondary transfer roller 32 secondarily transfers the color toner image on the intermediate transfer belt 21 to the sheet P collectively. The sheet P is fed from the paper feed cassette portion 16 or a manual paper feed tray 17 along the conveyance path 33.

The printer portion 18 includes a belt cleaner 43 facing the driven roller 41 through the intermediate transfer belt 21. The belt cleaner 43 removes the toner remaining on the intermediate transfer belt 21 after secondary transfer.

In the conveyance path 33, a resist roller 33a, the fixing device 34, and a paper discharge roller 36 are provided. On the downstream side of the fixing device 34 in the conveyance path 33, a branch portion 37 and a reversal conveyance portion 38 are provided. The branch portion 37 sends the sheet P after fixing to a paper discharge portion 20 or the reversal conveyance portion 38. In the case of both-side printing, the reversal conveyance portion 38 reverses and conveys the sheet P sent from the branch portion 37 to a direction of the resist roller 33a. The image forming device 10 forms the toner image on the sheet P by the printer portion 18 and discharges the sheet P to the paper discharge portion 20.

Incidentally, the image forming device 10 is not limited to a tandem developing system, and the number of developing devices 28 is also not limited. Further, the image forming device 10 may directly transfer the toner image to the sheet P from the photoconductive drum 24.

Hereinafter, the fixing device 34 will be described in detail.

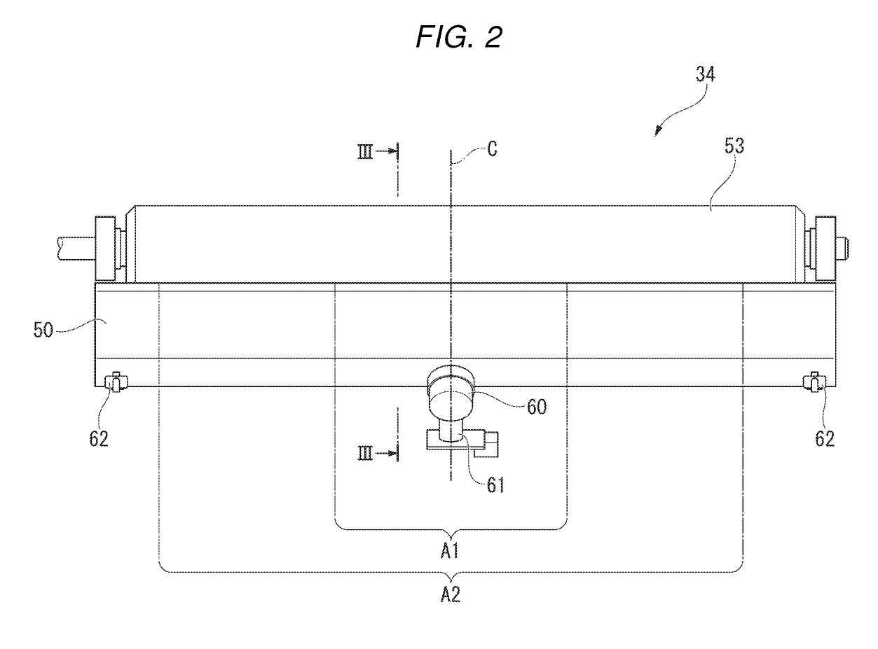

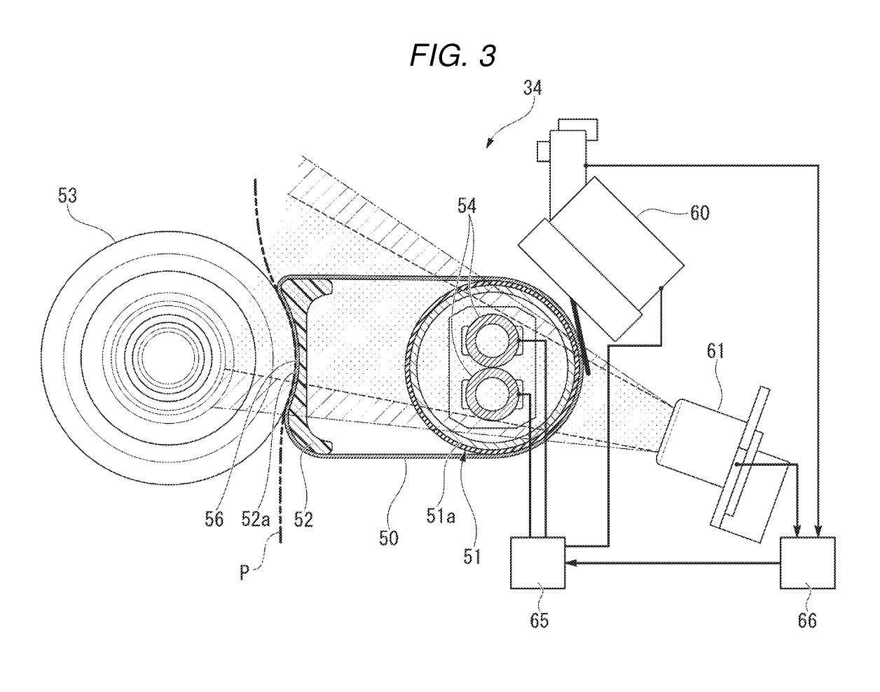

FIG. 2 is a top view of the fixing device 34. FIG. 3 is a cross-sectional view taken along the III-III line of FIG. 2 of the fixing device 34.

The fixing device 34 includes a fixing belt 50 which is a rotating endless belt, a heat roller 51 which holds the fixing belt 50 from the inside, a pad material 52, and a pressing roller 53 which is pressed against the outer surface of the pad material 52 through the fixing belt 50.

The heat roller 51 houses a halogen heater 54 which is a heating source of the heating device inside a core metal 51a in a cylindrical shape. The halogen heater 54 transmits heat to the outer surface side of the heat roller 51, and heats the fixing belt 50 by the heat. A portion heated by the heat roller 51 of the fixing belt 50 moves forward the support portion by the pad material 52 due to the rotational movement of the fixing belt 50.

Here, with respect to the heat roller 51, a side on which the pad material 52 is located is referred to as “front side”, and an opposite side to the side on which the pad material 52 is located is referred to as “rear side”. At a rear side position sandwiching the fixing belt 50 of the heat roller 51, a thermostat 60, a thermopile-type infrared temperature sensor 61, and a pair of thermistors 52 are disposed.

The thermostat 60 interrupts the current flow in the halogen heater 54 of the heat roller 51 according to the temperature in the vicinity of the fixing belt 50.

The infrared temperature sensor 61 is a non-contact-type temperature sensor. The infrared temperature sensor 61 detects the temperature of the outer surface of the fixing belt 50 at a central position in the width direction of the fixing belt 50. The central position in the width direction of the fixing belt 50 is a position through which (with which) the sheet P always passes (comes into contact) in the below-mentioned fixing nip portion 56. A detection signal of the infrared temperature sensor 61 is output to a temperature control portion 66 of the halogen heater 54. The temperature control portion 66 controls a feeder circuit 65 of the halogen heater 54 so that the temperature of the fixing belt 50 is maintained at an appropriate temperature.

The thermistor 52 is a contact-type temperature sensor which detects a temperature by coming into contact with the outer surface of the fixing belt 50. The thermistor 52 detects the temperature of the outer surface of the fixing belt 50 in portions on both sides in the width direction of the fixing belt 50. A side part region of the fixing belt 50 whose temperature is detected by the thermistor 52 is a region through which (with which) the sheet P does not pass (does not come into contact) in the below-mentioned fixing nip portion 56. A detection signal of the thermistor 52 is output to the temperature control portion 66 of the halogen heater 51. The temperature control portion 66 controls the feeder circuit 65 of the halogen heater 51 so that the temperature of the fixing belt 50 is maintained at an appropriate temperature.

Incidentally, the heating source which heats the fixing belt 50 is not limited to the halogen heater 51, and may be, for example, an electromagnetic induction heater, a carbon heater, or the like.

The heat roller 51 is supported by a frame member (not shown) of the image forming device 10 through a drive motor (not shown) and a bearing (not shown). The drive motor rotates the heat roller 51 in the opposite direction to the driving rotational direction of the pressing roller 53. However, the heat roller 51 is driven at a rotational speed which is slightly slower than the pressing roller 53.

The pad material 52 is formed of a hard resin material and is held by a stay (not shown). The stay is supported by a frame member (not shown) of the image forming device 10. The pad material 52 extends in a direction along the width direction of the fixing belt 50.

On a side facing the pressing roller 53 of the pad material 52, a concave portion 52a having an arc surface substantially along the outer surface of the pressing roller 53 is formed. The fixing belt 50 is hung on the heat roller 51 and the pad material 52. The heat roller 51 and the pad material 52 are formed longer than the width of the fixing belt 50. The fixing belt 50 abuts on the outer circumferential surface of the pressing roller 53 in the concave portion 52a of the pad material 52. The pressing roller 53 is rotationally operated by a drive motor (not shown). The fixing belt 50 receives a rotational force from the pressing roller 53 in the concave portion 52a of the pad material 52, and rotates in an opposite direction to the rotational direction of the pressing roller 53. At this time, the fixing belt 50 slides on the outer surface of the pad material 52.

Further, between the fixing belt 50 located at a position facing the concave portion 52a of the pad material 52 and the outer circumferential surface of the pressing roller 53, a fixing nip portion 56 which allows the sheet P to pass therethrough is formed. The sheet P passing through the fixing nip portion 56 is pressed by being sandwiched between the pad material 52 and the pressing roller 53, and also thermal energy is applied thereto by the fixing belt 50 heated by the heat roller 52. The toner image formed on the sheet P is fixed on the sheet P in the meantime.

By the way, the thermostat 60 which operates in response to the temperature in the vicinity of the fixing belt 50 and the infrared temperature sensor 61 which detects the surface temperature of the fixing belt 50 are disposed facing a central position C in the width direction of the fixing belt 50. That is, the thermostat 60 and the infrared temperature sensor 61 are disposed in the same phase position in the width direction of the fixing belt 50. Further, the thermostat 60 and the infrared temperature sensor 61 are disposed facing a surface (outer surface) on the same side (inside or outside) of the fixing belt 50.

Incidentally, in the embodiment, the thermostat 60 and the infrared temperature sensor 61 are disposed facing the central position C in the width direction of the fixing belt 50, however, the position may not be the central position C in the width direction as long as the position is the same phase position in the width direction of the fixing belt 50. However, the thermostat 60 and the infrared temperature sensor 61 are desirably disposed in a region A1 (see FIG. 2) in the width direction through which the sheet P of the minimum size passes in the fixing nip portion 56 in the fixing belt 50. The reference numeral A2 in FIG. 2 shows a region in the width direction through which the sheet P of the maximum size passes in the fixing nip portion 56 in the fixing belt 50.

Further, the infrared temperature sensor 61 is disposed on a lower rear side of the axial center position of the heat roller 51, and a temperature detection portion is inclined obliquely upward forward the axial center of the heat roller 51. On the other hand, the thermostat 60 is disposed on an upper rear side of the axial center position of the heat roller 51, and a temperature sensing portion is inclined obliquely downward forward the axial center of the heat roller 51. The thermostat 60 is disposed at a position above the infrared temperature sensor 61. Further, the thermostat 60 and the infrared temperature sensor 61 are disposed at positions in proximity to the heat roller 51 (heating device) in the fixing belt 50.

In the fixing device 34 of the embodiment, the thermostat 60 and the infrared temperature sensor 61 which is one of the temperature sensors are disposed on the same surface side of the fixing belt 50 and also in the same phase position in the width direction of the fixing belt 50. Due to this, the temperature sensing by the thermostat 60 and the temperature detection by the infrared temperature sensor 61 can be performed at a position in the width direction on the fixing belt 50 which comes into contact with the sheet P similarly in the fixing nip portion 56. In the fixing device 34 of the embodiment, the difference between the temperature of a region sensed by the thermostat 60 and the temperature of a region detected by the infrared temperature sensor 61 on the fixing belt 50 can be reduced.

Further, in the fixing device 34 of the embodiment, the thermostat 60 and the infrared temperature sensor 61 are disposed facing the outer surface side of the fixing belt 50. Due to this, the temperature close to the temperature of a portion which actually comes into contact with the sheet P in the fixing nip portion 56 can be detected by the infrared temperature sensor 61.

Incidentally, the thermostat 60 and a temperature sensor such as an infrared temperature sensor can also be disposed inside the fixing belt 50 so as to face the inner surface side of the fixing belt 50. In this case, the fixing device can be made compact.

Further, in the fixing device 34 of the embodiment, the thermostat 60 and the infrared temperature sensor 61 are disposed in the region Al in the width direction through which the sheet P of the minimum size passes in the fixing nip portion 56 in the fixing belt 50. Due to this, the difference between the temperature of a region sensed by the thermostat 60 and the temperature of a region detected by the infrared temperature sensor 61 on the fixing belt 50 can be reduced regardless of the size of the sheet P.

In particular, as in the embodiment, when the thermostat 60 and the infrared temperature sensor 61 are disposed at the central position C in the width direction in the fixing belt 50, even if the feeding position in the width direction of the sheet P is somewhat deviated, the difference between the temperature of a region sensed by the thermostat 60 and the temperature of a region detected by the infrared temperature sensor 61 on the fixing belt 50 can be reliably reduced.

Further, in the fixing device 34 of the embodiment, the temperature sensor which detects the temperature in a central region of the fixing belt 50 is constituted by the infrared temperature sensor 61 which is a non-contact-type sensor, and therefore, an unnecessary resistance is prevented from being applied to the fixing belt 50 or the surface temperature of the fixing belt 50 is prevented from changing. Incidentally, in the embodiment, the infrared temperature sensor 61 is adopted as one example of the non-contact-type temperature sensor, however, the non-contact-type temperature sensor may be a temperature sensor of a type other than the infrared temperature sensor 61.

Further, in the fixing device 34 of the embodiment, the thermostat 60 is disposed on the upper side of the infrared temperature sensor 61. Due to this, the heating state of the fixing belt 50 can be sensed more sensitively by the thermostat 60 than by the infrared temperature sensor 61.

Further, in the fixing device 34 of the embodiment, the thermostat 60 and the infrared temperature sensor 61 are disposed at positions in proximity to the heat roller 51 (heating device) in the fixing belt 50. Due to this, the temperature changing state on the fixing belt 50 can be sensed sensitively.

Further, in the case of the embodiment, a configuration in which the fixing belt 50 is provided in contact with the outer surface of the heat roller 51 in a tensioned state, and therefore, a portion on which the fixing belt 50 is hung can be made compact. Due to this, an occupied space of the entire fixing device 34 including the thermostat 60 and the infrared temperature sensor 61 can be made small.

According to at least one embodiment described above, the difference between the temperature of a region sensed by the thermostat and the temperature of a region detected by the temperature sensor on the fixing belt can be reduced regardless of the size of the recording medium to be used or the feeding position in the width direction of the recording medium.

1. A fixing device, comprising:
a heating device;
a fixing belt which is heated by the heating device and also rotates;
a pressing roller which is pressed toward the outer surface of the fixing belt, and also forms a fixing nip portion through which a recording medium as a fixing target passes between the pressing roller and the outer surface of the fixing belt;
a thermostat which is disposed in proximity to the fixing belt, and interrupts the current flow in the heating device according to a temperature in the vicinity of the fixing belt; and
a temperature sensor which is disposed in proximity to the fixing belt, and detects the temperature of the fixing belt and outputs a detection signal to a temperature control portion of the heating device, wherein
the thermostat and the temperature sensor are disposed on the same surface side of the fixing belt and also in the same position in the width direction of the fixing belt.

2. The device according to claim 1, wherein the thermostat and the temperature sensor are disposed facing the outer surface of the fixing belt.

3. The device according to claim 1, wherein the thermostat and the temperature sensor are disposed facing the inside of a region in the width direction of the fixing belt through which the recording medium of the minimum size passes in the fixing nip portion in the fixing belt.

4. The device according to claim 3, wherein the thermostat and the temperature sensor are disposed facing a central position in the width direction of the fixing belt.

5. The device according to claim 1, wherein the temperature sensor is a non-contact-type sensor which does not come into contact with the fixing belt.

6. The device according to claim 1, wherein the thermostat is disposed at a position on an upper side of the temperature sensor.

7. The device according to claim 1, wherein the thermostat and the temperature sensor are disposed at positions in proximity to the heating device in the fixing belt.

8. The device according to claim 1, wherein the fixing belt is provided in contact with the outer surface of a heat roller incorporating a heating device therein in a tensioned state.

9. The device according to claim 1, wherein the thermostat and the temperature sensor are disposed inside the fixing belt so as to face the inner surface of the fixing belt.

10. An image forming device, comprising:
a printer portion which transfers a toner image onto a recording medium; and
a fixing device which fixes a toner by applying heat to the recording medium having the toner image transferred thereonto, wherein
the fixing device includes
a heating device,
a fixing belt which is heated by the heating device and also rotates,
a pressing roller which is pressed toward the outer surface of the fixing belt, and also forms a fixing nip portion through which a recording medium as a fixing target passes between the pressing roller and the outer surface of the fixing belt,
a thermostat which is disposed in proximity to the fixing belt, and interrupts the current flow in the heating device according to a temperature in the vicinity of the fixing belt, and
a temperature sensor which is disposed in proximity to the fixing belt, and detects the temperature of the fixing belt and outputs a detection signal to a temperature control portion of the heating device, and
the thermostat and the temperature sensor are disposed on the same surface side of the fixing belt and also in the same phase position in the width direction of the fixing belt.
